(19) United States
(12) Patent Application Publication
(10) Pub. No.: US 2011/0078224 A1
(43) Pub. Date: Mar. 31, 2011

(54) Nonlinear Dimensionality Reduction of Spectrograms

(76) Inventors: Kevin W. Wilson, Cambridge, MA (US); Bhiksha R. Ramakrishnan, Pittsburgh, PA (US)

(21) Appl. No.: 12/571,156

(22) Filed: Sep. 30, 2009

(51) Int. Cl. G06F 17/14; G06F 17/16

(52) U.S. Cl. 708/401

(57) ABSTRACT

Embodiments of the invention disclose a system and a method for reducing a dimensionality of a spectrogram matrix. The method constructs an intermediate time basis matrix and an intermediate frequency basis matrix and applies iteratively a non-negative matrix factorization (NMF) to the intermediate time basis matrix and the intermediate frequency basis matrix until a termination condition is reached, wherein the NMF is subject to a constraint on a an independence regularization term, wherein the constraint is in a form of a gradient of the term.

### FIELD OF THE INVENTION

This invention relates generally to a method for reducing dimensionality of spectrograms of time-varying signals, and more particularly to representing the spectrograms as independent basis matrices.

### BACKGROUND OF THE INVENTION

Typical examples of signals varying over time are acoustic signals, such as speech, mechanical vibrations, and electro-magnetic signals. In signal processing, such signals are generated by “processes,” and signals are frequently referred to as “time series” data. Time-varying signals can be represented as magnitude spectrograms. All values of the magnitude spectrograms are nonnegative.

In many applications, it is useful to decompose the magnitude spectrogram into a small number of independent components, especially when the spectrogram is concurrently generated by multiple independent processes.

The decomposition can be performed by factoring the magnitude spectrogram. The factoring reduces the spectrogram to basis matrices, which are a low-dimensional representation of the spectrogram. Then the basis matrices can be used for classification, denoising, or source separation.

Hence, it is desired to represent the spectrograms of time-varying signals as a convex combination of a small number of independent, nonnegative basis matrices.

### SUMMARY OF THE INVENTION

Embodiments of the invention disclose a system and a method for reducing a dimensionality of a spectrogram matrix. The embodiments constructs an intermediate time basis matrix and an intermediate frequency basis matrix and applies iteratively a non-negative matrix factorization (NMF) to the intermediate time basis matrix and the intermediate frequency basis matrix until a termination condition is reached, wherein the NMF is subject to a constraint on a an independence regularization term, wherein the constraint is in a form of a gradient of the term.

One embodiment discloses a method for reducing a dimensionality of a spectrogram of a signal produced by a number of independent processes, the spectrogram is represented by a spectrogram matrix such that the spectrogram matrix is factored into a combination of a frequency basis matrix and a time basis matrix, wherein values of rows of the time basis matrix are substantially independent, comprising a processor for performing steps of the method, comprising the following steps.

The method acquires an intermediate frequency basis matrix having a number of columns equal to the number of independent processes and a number of rows equal to the number of rows in the spectrogram matrix, an intermediate time basis matrix having a number of rows equal to the number of independent processes and a number of columns equal to the number of columns in the spectrogram matrix; and a gradient of an independence regularization requirement.

Next, the method updates the intermediate frequency basis matrix and the intermediate time basis matrix according to a non-negative matrix factorization (NMF) with the gradient of the independence regularization requirement, and selects the intermediate frequency basis matrix as the frequency basis matrix and the intermediate time basis matrix as the time basis matrix, if a termination condition is reached. Otherwise the updating is repeated.

### BRIEF DESCRIPTION OF THE DRAWINGS

FIG. 1 is a schematic of representing a spectrogram as a matrix;

FIG. 2 is a schematic of representing a spectrogram matrix as independent basis matrices; and

FIG. 3 is a block diagram of a regularized non-negative matrix factorization (RNMF) according embodiments of invention.

### DETAILED DESCRIPTION OF THE PREFERRED EMBODIMENT

Our invention is based on a realization that a spectrogram represented by a matrix can be factored into a frequency basis matrix and a time basis matrix using a regularized non-negative matrix factorization (RNMF) with a specific regularization term describing an independence constraint such that the time basis matrix has uncorrelated rows.

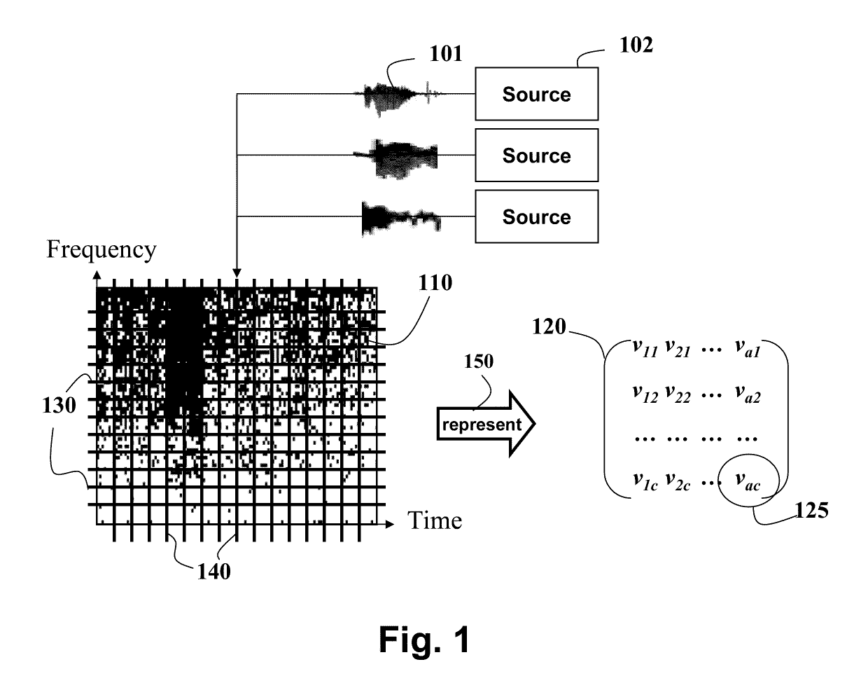

FIG. 1 shows an example of a spectrogram 110. The spectrogram 110 is generated from signals 101 acquired from multiple independent acoustic sources 102 or processes, e.g., people talking. The spectrogram can be represented 150 as a spectrogram matrix V 120.

Rows in the matrix V represent different frequencies F 130 of the spectrogram, and columns represent times T 140. Accordingly, a value of the spectrogram 110, i.e., an amplitude of a particular frequency at a particular time, form elements v 125 of the spectrogram matrix. Hence, the spectrogram matrix V is a nonnegative matrix of size F*T.

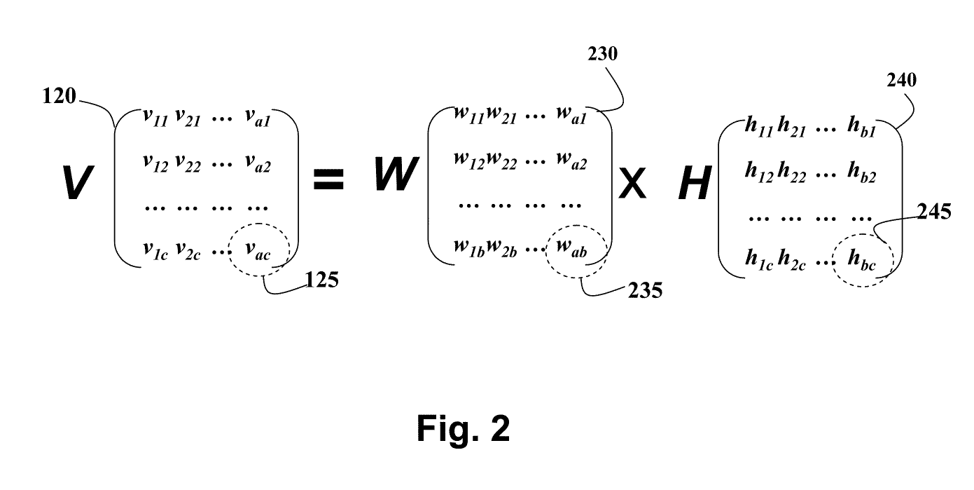

As shown on FIG. 2, embodiments of the invention decompose the matrix V into two matrices by factoring, i.e., a frequency basis matrix W 230 and a time basis matrix H 240. The matrices W and H are nonnegative matrices of size F*n and n*T, respectively, where n is a number of independent processes that generates the spectrogram 110. The number n is a positive integer less than the minimum of F and T, e.g., in the spectrogram 110 n=3. The columns of the frequency basis matrix W represent a spectral shape of the signal produced by each independent process. The rows of the time basis matrix H represent the time-dependent activation level of each independent process.

Because the processes forming the spectrogram are independent, the time basis matrix has uncorrelated elements, i.e., the rows are independent of each other. Accordingly, the decomposition

V=WH,

is constrained by

W_{ab}≧0∀a,b

H_{bc}≧0∀b,c

V_{ac}≧0∀a,c

E(HH^{T})≈diag(E(HH^{T})) (1)

where W_{ab} 235 and H_{bc} 345 are elements of matrices W and H respectively, and a function E( ) is an expectation over all of the vectors in the matrix H. A function diag( ) is a diagonal matrix with the same diagonal elements as an argument of the function.

Embodiments of the invention determine solution of Equation (1) based on minimization of RNMF according to

$$D ( W , H ) = \frac{1}{2} {‖ V - WH ‖}_{F}^{2} + α J ( H ) , \qquad ( 2 )$$

where ∥V−WH∥_{F}² is a reconstruction error, i.e., a Frobenius norm of a difference between the spectrogram matrix V, and factorized approximation WH. Ideally, the reconstruction error should be 0. J(H) represents an independence regularization requirement for the time basis matrix H, and a is a scalar weight for the independence regularization requirement during an optimization process.

The independence regularization requirement J(H) is selected such that when the requirement is minimized, the correlation between the rows of the time basis matrix H is also minimized.

In one embodiment, we use the Frobenius norm of the empirical correlation of matrix H according to

J(H)=∥C(H)∥_{F}² (3)

C(H)=P_{H}^{-1/2}HH^{T}P_{H}^{-1/2}, (4)

where C(H) is an energy-normalized correlation matrix of H, P_{H} is a diagonal matrix of energies, e.g., sums of squares, of the rows of the time basis matrix H. The diagonal elements of the matrix C(H) are one. Thus, minimization of the Frobenius norm forces non-diagonal elements toward zero.

We update the RNMF with the independence regularization requirement of the matrix H according to

$${W}_{ab} ← {W}_{ab} \frac{{[ {VH}^{T} ]}_{ab}}{{[ {WHH}^{T} ]}_{ab}} \\ {H}_{bc} ← {H}_{bc} \frac{{⌊ {[ {W}^{T} V ]}_{bc} - α ϕ ( {H}_{bc} ) ⌋}_{ɛ}}{{[ {W}^{T} WH ]}_{bc} + ɛ} , \qquad ( 5 )$$

where ε is a small positive constant and [ ]_{ε} indicates that any values within the brackets less than ε are replaced with ε to prevent violations of the nonnegativity constraint. A gradient of the independence regularization requirement J(H) with respect to time basis matrix H is φ(H), and

$$\begin{matrix}ϕ ( {H}_{bc} ) = \frac{\partial J ( H )}{\partial {H}_{bc}} & ( 6 ) \\ = {\sum }_{i} {\sum }_{j} {C}_{ij} \frac{\partial {C}_{ij}}{\partial {H}_{bc}} , and & ( 7 ) \\ \frac{\partial {C}_{ij}}{\partial {H}_{bc}} = \frac{{B}_{ij} ( \partial {A}_{ij} / \partial {H}_{bc} ) - {A}_{ij} ( \partial {B}_{ij} / \partial {H}_{bc} )}{{B}_{ij}^{2}} , & ( 8 )\end{matrix}$$

where variable A and B are defined according to

A=HH^{T}, (9)

B=NN^{T}, (10)

N_{b}=∥H_{b}∥, (11)

δAᵢⱼ/δH_{bc}=1_{b}H_{c}^{T}+H_{c}1_{b}^{T}, (12)

δBᵢⱼ/δH_{bc}=H_{bc}(U1_{b}1_{b}^{T}+1_{b}1_{b}^{T}U^{T}, and (13)

U=N(N⁻¹)^{T}, (14)

where 1_{b} is an indicator vector having a zero value for all elements, except the b^{th} element that is one. N is a vector whose elements are norms of the rows of the time basis matrix H, and U is an outer product of the vector N where the elements are inverted.

The gradient φ(H) imposes an independence constraint on the rows of the time basis matrix H. The desired decomposition achieves time-dependent activation levels of the processes generating the spectrogram. Thus, an activation levels for one process, i.e., the elements in one row of the matrix H provides no information about the activation levels for another process, i.e., the elements in another row of the matrix H.

Accordingly, the embodiments of the invention provide a novel gradient constraint for the independence regularization requirement, which leads to a substantial independence of elements of the rows of the matrix H, wherein the rows are independent or nearly independent of each other.

Method for Nonlinear Dimensionality Reduction of Spectrograms

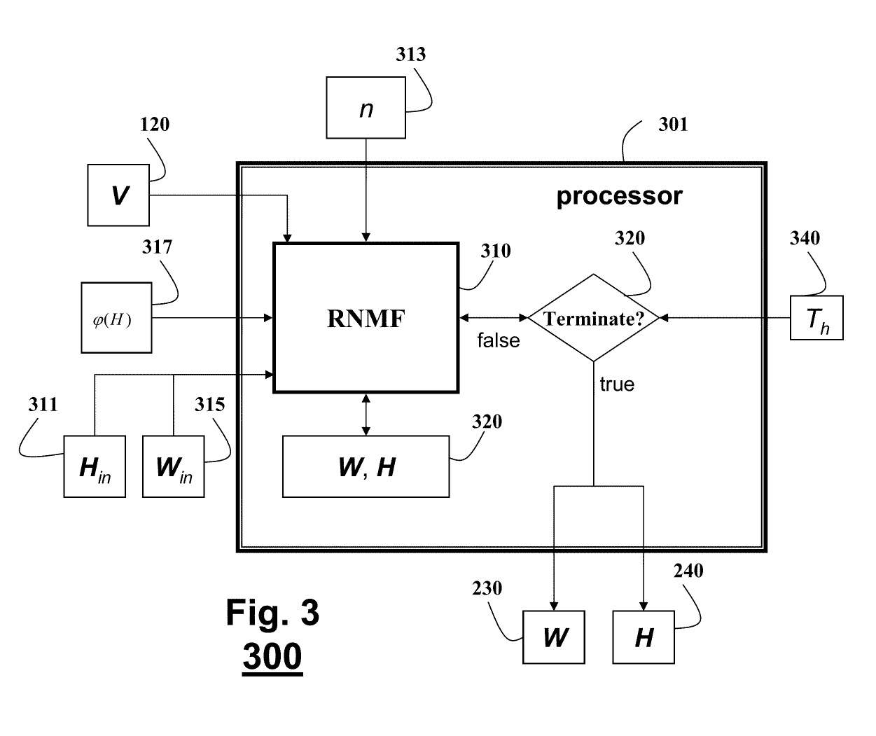

FIG. 3 shows a method 300 for reducing a dimensionality of a spectrogram. Steps of the method 300 can be performed by a processor 301 including memory and input/output interfaces. The method includes a regularized non-negative matrix factorization (RNMF) 310, which is performed iteratively, until a termination condition 320 is satisfied.

Inputs to the method include the spectrogram matrix 120, the number n 313 of independent processes generating the spectrogram, an intermediate time basis matrix Hᵢₙ 311, an intermediate frequency basis matrix Wᵢₙ 315, a gradient φ(H) 317 of an independence regularization requirement, and a threshold Tₕ 340.

The spectrogram matrix represents the spectrogram acquired from the n independent processes. The number of independent processes is less than a number of rows in the spectrogram matrix 120, i.e., less than the number of frequency bands 130 in the spectrogram 110. The intermediate time basis matrix Hᵢₙ is constructed at random with a number of rows equal to the number n and a number of columns equal to the number of columns in the spectrogram matrix 120. The intermediate frequency basis matrix Wᵢₙ 315 is constructed at random with a number of columns equal to the number n and a number of rows equal to the number of rows in the spectrogram matrix 120. The threshold 340 can indicate a number of iterations, or a difference in values between the current and previous iterations.

In each iteration, the RNMF 310 determines frequency and time basis matrices W, H 320 according Equation (5), with the gradient φ(H) defined according to Equations (6)-(14).

Satisfaction of the termination condition is checked 320. If the condition is false, the RNMF is repeated with updated factors W, H 320. Otherwise, if true, the matrix W 230 and matrix H 240 are output.

Although the invention has been described by way of examples of preferred embodiments, it is to be understood that various other adaptations and modifications may be made within the spirit and scope of the invention. Therefore, it is the object of the appended claims to cover all such variations and modifications as come within the true spirit and scope of the invention.

We claim:

1. A method for reducing a dimensionality of a spectrogram of a signal produced by a number of independent processes, the spectrogram is represented by a spectrogram matrix such that the spectrogram matrix is factored into a combination of a frequency basis matrix and a time basis matrix, wherein values of rows of the time basis matrix are substantially independent, comprising a processor for performing steps of the method, comprising the steps of:
acquiring an intermediate frequency basis matrix having a number of columns equal to the number of independent processes and a number of rows equal to the number of rows in the spectrogram matrix;
acquiring an intermediate time basis matrix having a number of rows equal to the number of independent processes and a number of columns equal to the number of columns in the spectrogram matrix;
acquiring a gradient of an independence regularization requirement;
updating the intermediate frequency basis matrix and the intermediate time basis matrix according to a non-negative matrix factorization (NMF) with the gradient of the independence regularization requirement; and
selecting the intermediate frequency basis matrix as the frequency basis matrix and the intermediate time basis matrix as the time basis matrix, if a termination condition is reached; and otherwise
repeating the updating.

2. The method of claim 1, further comprising:
selecting the number of independent processes such that the number of the independent processes is less than a number of rows in the spectrogram matrix.

3. The method of claim 1, further comprising:
selecting the number of independent processes such that the number of the independent processes is less than a number of columns in the spectrogram matrix.

4. The method of claim 1, wherein the acquiring the intermediate frequency basis matrix further comprising:
constructing at random the intermediate frequency basis matrix.

5. The method of claim 1, wherein the acquiring the intermediate time basis matrix further comprising:
constructing at random the intermediate time basis matrix.

6. The method of claim 1, wherein the gradient is according to
$$ϕ ( {H}_{bc} ) = \frac{\partial J ( H )}{\partial {H}_{bc}} = {\sum }_{i} {\sum }_{j} {C}_{ij} \frac{\partial {C}_{ij}}{\partial {H}_{bc}} ,$$
wherein φ(H) is the gradient of the independence regularization requirement J(H) with respect to the time basis matrix H, and
$$\frac{\partial {C}_{ij}}{\partial {H}_{bc}} = \frac{{B}_{ij} ( \partial {A}_{ij} / \partial {H}_{bc} ) - {A}_{ij} ( \partial {B}_{ij} / \partial {H}_{bc} )}{{B}_{ij}^{2}} ,$$
wherein variable A and B are defined according to
A=HH^{T}
B=NN^{T}
N_{b}=∥H_{b}∥
δAᵢⱼ/δH_{bc}=1_{b}H_{c}^{T}+H_{c}1_{b}^{T}
δBᵢⱼ/δH_{bc}=H_{bc}(U1_{b}1_{b}^{T}+1_{b}1_{b}^{T}U^{T})
U=N(N⁻¹)^{T}
wherein 1_{b} is an indicator vector having a zero value for all elements, except a value of b^{th} element is one, N is a vector whose elements are norms of the rows of the time basis matrix H, and U is an outer product of the vector N where the elements are inverted.

7. A method for reducing a dimensionality of a spectrogram of a signal produced by a number of independent processes, comprising a processor for performing steps of the method, comprising the steps of:
representing the spectrogram by a spectrogram matrix, wherein elements of each column of the spectrogram matrix represents frequency amplitudes at a particular time in the spectrogram;
constructing an intermediate time basis matrix, wherein a number of rows is equal to a number of the independent processes, and a number of columns is equal to a number of columns in the spectrogram matrix;
constructing an intermediate frequency basis matrix, wherein a number of columns is equal to the number of independent processes, and a number of rows is equal to the number of rows in the spectrogram matrix; and
applying iteratively a non-negative matrix factorization (NMF) to the intermediate time basis matrix and the intermediate frequency basis matrix until a termination condition is reached, wherein the NMF is subject to a constraint on a an independence regularization term, wherein the constraint is in a form of a gradient of the term.

8. The method of claim 7, further comprising:
updating the intermediate time basis matrix and the intermediate frequency basis matrix based on a result of the NMF.

9. The method of claim 7, further comprising:
acquiring the number of independent processes, wherein the number of the independent processes is less than a number of rows in the spectrogram matrix.

10. The method of claim 7, further comprising:
acquiring the number of independent processes, wherein the number of the independent processes is less than a number of columns in the spectrogram matrix.

11. The method of claim 7, wherein the constructing the intermediate frequency basis matrix further comprising:
constructing at random the intermediate frequency basis matrix.

12. The method of claim 7, wherein the constructing the intermediate time basis matrix further comprising:
constructing at random the intermediate time basis matrix.

13. A system for reducing a dimensionality of a spectrogram of a signal produced by a number of independent processes, the spectrogram is represented by a spectrogram matrix such that the spectrogram matrix is factored into a combination of a frequency basis matrix and a time basis matrix, wherein values of rows of the time basis matrix are substantially independent, comprising:
means for constructing an intermediate time basis matrix at random, wherein a number of rows in the intermediate time basis is equal to the number of the independent processes, and a number of columns in the intermediate time basis is equal to a number of columns in the spectrogram matrix;
means for constructing an intermediate frequency basis matrix, wherein a number of columns in the intermediate frequency basis matrix is equal to the number of independent processes, and a number of rows in the intermediate frequency basis matrix is equal to the number of rows in the spectrogram matrix;
means for applying iteratively a non-negative matrix factorization (NMF) to the intermediate time basis matrix and the intermediate frequency basis matrix until a termination condition is reached, wherein the NMF is subject to a constraint on a an independence regularization term, wherein the constraint is in a form of a gradient of the term, and wherein the NMF updates the intermediate time basis matrix and the intermediate frequency basis matrix.

14. The system of claim 13, wherein the number of independent processes is selected at random.
